(19) United States
(12) Patent Application Publication
(10) Pub. No.: US 2009/0243328 A1
(43) Pub. Date: Oct. 1, 2009

(54) VEHICLE FOOTREST CONTAINER

(76) Inventor: Delray Graves, Washington, UT (US)

Correspondence Address: TERRENCE J. EDWARDS;CLAYTON, HOWARTH & CANNON, P.C., P.O. BOX 1909, SANDY, UT, 84091, US

(21) Appl. No.: 12/060,147

(22) Filed: Mar. 31, 2008

(51) Int. Cl. B60N 3/06

(52) U.S. Cl. 296/75

(57) ABSTRACT

A vehicle footrest, such as a floorboard or footpeg, comprising a container or compartment adapted for attaching to a vehicle, such as a motorcycle or other recreational vehicle, is disclosed. The footrest may be used to support a rider's foot and ankle, while providing a rider with a convenient container for carrying items, such as tools or personal property. The footrest may include a first part and a second part. The first part may include a top surface that may support the rider's foot. The first part may be attached to the second part, which may be substantially hollow, with a hinge to thereby form a container or compartment that can be opened and closed. The container or compartment may be attached to the vehicle with a mounting assembly that may accommodate numerous styles and makes of vehicles.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

1. The Field of the Invention

The disclosure relates generally to vehicle footrests, and more particularly, but not necessarily entirely, to a device that may be used as a footrest and a container for motorcycles or recreational vehicles.

2. Description of Related Art

Riders of motorcycles and other recreational vehicles typically sit astride the vehicle on a saddle at a comfortable arm's length from a handle bar that provides the rider with the ability to steer motorcycle or other recreational vehicle in a desired manner. The rider's feet are traditionally supported by footrests while in a seated position. Generally, there are two different types of footrests for motorcycles and other recreational vehicles, namely footpegs and floorboards.

Footpegs are short shafts that typically extend outwardly from a vehicle frame in a lateral direction. Footpegs are commonly used and are the most widely used footrest because footpegs traditionally are simple in operation and design and function very well. Further, footpegs having a stirrup have become increasingly popular because of the heel rest that extends from the shaft of the peg can provide added comfort and support for the heel of the rider's foot.

On the other hand, floorboards provide a motorcycle or recreational vehicle rider with a different foot support than the traditional footpeg. Floorboards may provide a flat, upwardly-sloped surface that faces the rider and operates to support both the sole and heel portion of the rider's shoe or boot. Floorboards are generally known to provide greater rider comfort because the floorboard is a solid surface that constitutes a fixed angle to complement and support the rider's ankle and foot.

In contrast, a rider's shoe or boot can rotate about a footpeg, requiring more effort on the part of the rider to hold the foot in a fixed position. Floorboards are often used with cruisers, choppers, and touring motorcycles and provide a certain distinguishable look and comfort for a rider. It will be appreciated that both footpegs and floorboards have their own distinct advantages.

Further, it will be appreciated that motorcycles and other recreational vehicles are mechanical devices that require maintenance. On occasion, a particular motorcycle or recreational vehicle may require some form of maintenance when a rider is using the vehicle, which may have become apparent during use or otherwise. Many motorcycles and other recreational vehicles are equipped with compartments or containers for carrying personal items or other property, including tools for on the road maintenance.

Motorcycles and other recreational vehicles may be equipped with hard or leather saddle bags, sissy bar bags, tool bags, trunks or other containers. Many of these containers are located on the outer dimensions of the back end of the motorcycle and these containers may be considered by some riders to be bulky and unattractive. The containers or compartments may even be located under the saddle of the motorcycle in the area of the motorcycle traditionally reserved for the air box. In those instances, the container or compartment may be effecting the mechanics of the motorcycle because the air box must be shifted to another area to accommodate the container or compartment.

Despite the advantages of known containers and compartments for motorcycles and other recreational vehicles, improvements are still being sought. However, containers and compartments on the market are characterized by several disadvantages that may be addressed by the disclosure. The disclosure minimizes, and in some aspects eliminates, the failures and inadequacies of the containers and compartments known on the market, and other problems, by utilizing the methods and structural features described herein.

The features and advantages of the disclosure will be set forth in the description that follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a perspective view of a vehicle footrest in a partially opened position made in accordance with the principles of the disclosure;

FIG. 2 is a perspective view of a vehicle footrest in a closed position made in accordance with the principles of the disclosure;

FIG. 3 is a perspective view of a vehicle footrest in an opened position made in accordance with the principles of the disclosure;

FIG. 4 is a top view of a vehicle footrest in a closed position made in accordance with the principles of the disclosure;

FIG. 5 is side view of a vehicle footrest in a closed position made in accordance with the principles of the disclosure;

FIG. 6 is a front view of a vehicle footrest in a closed position made in accordance with the principles of the disclosure;

FIG. 7 is a perspective, side view of a vehicle footrest in a closed position made in accordance with the principles of the disclosure;

FIG. 8 is a perspective, side view of a vehicle footrest in a partially opened position made in accordance with the principles of the disclosure;

FIG. 9 is a side view of a vehicle footrest in a partially opened position made in accordance with the principles of the disclosure;

FIG. 10 is a front view of a vehicle footrest in a partially opened position made in accordance with the principles of the disclosure; and

FIG. 11 is an exploded view of a vehicle footrest illustrating a first part, an insert, a second part, and a mounting structure in accordance with the principles of the disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the structural features of the floorboard container are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

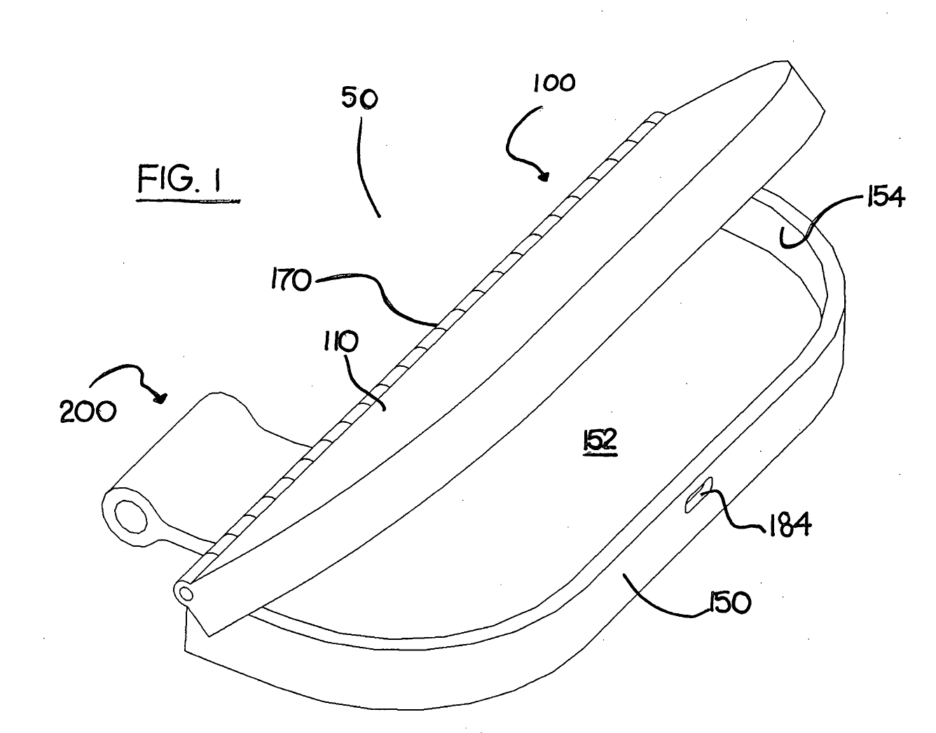

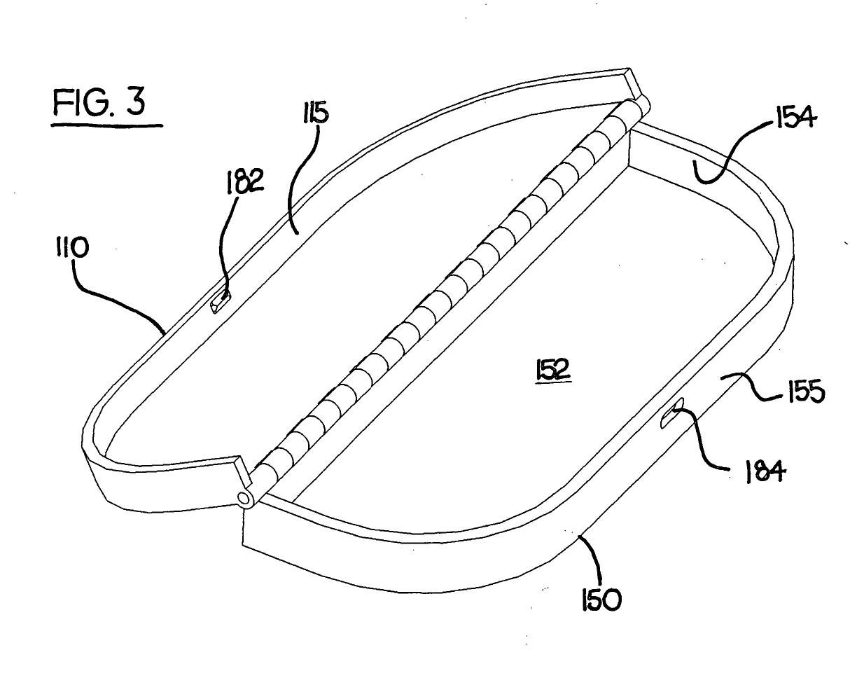

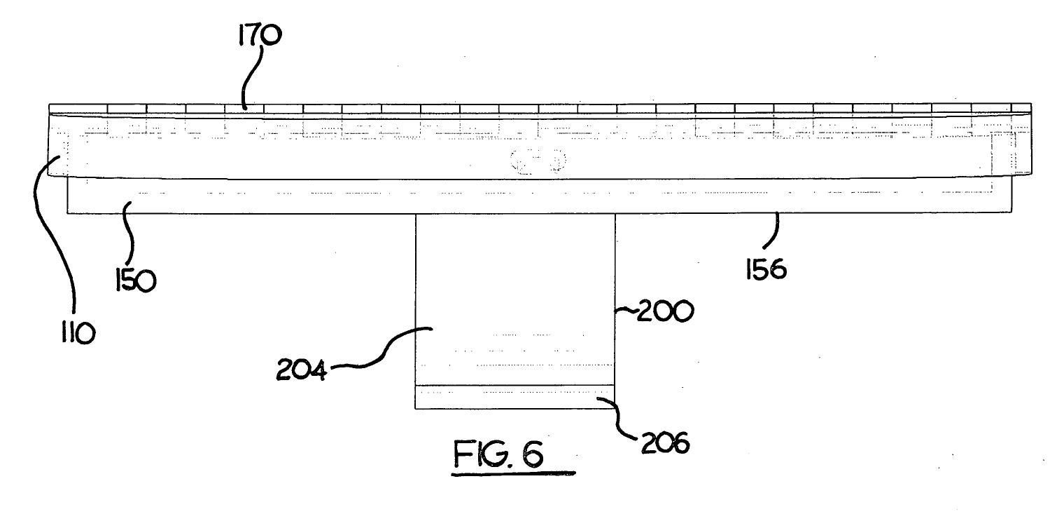

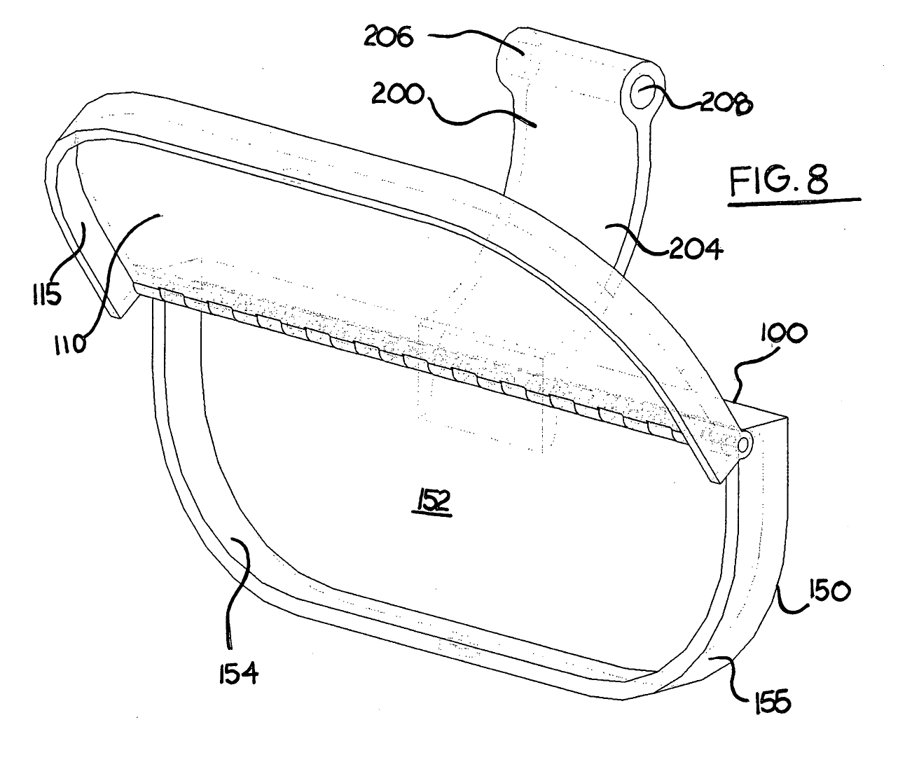

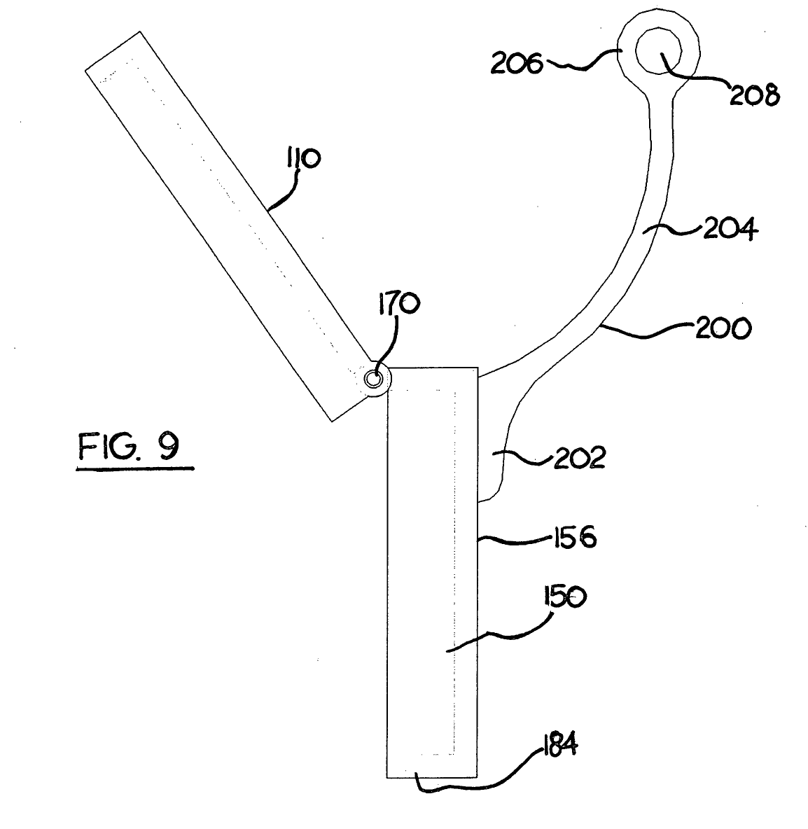

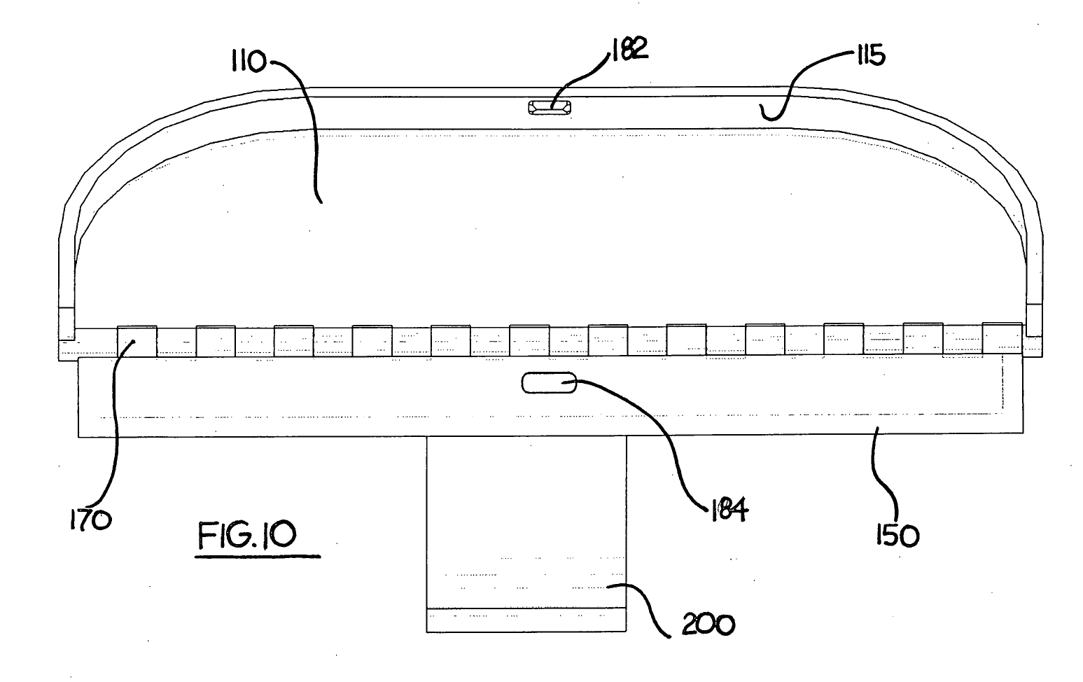

Referring now to FIGS. 1-11, the disclosure relates to a vehicle footrest kit 50 and a vehicle footrest 100. The kit 50 may include the vehicle footrest 100 and a mounting structure 200 for connecting the footrest 100 to the vehicle 10. The footrest 100 may comprise a first part 110 having a first surface 112 and a second part 150 connectable to the first part 110. The second part 150 may comprise a substantially hollow interior 152 as best illustrated in FIGS. 1 and 3.

It will be appreciated that the substantially hollow interior 152 of the second part 150 may include a volume that may fall within a range of about K(12 cubic inches to 336 cubic inches). Alternatively, the volume of the substantially hollow interior 152 may be between a range of about K(36 cubic inches to 225 cubic inches). In another alternative, the volume of the substantially hollow interior 152 may be between a range of about K(45 cubic inches to 188 cubic inches). It is to be understood that all values falling within the ranges provided above are within the scope of the disclosure. It will be appreciated that K is a constant between 0.8 and 1.2 and may be used as a scaling factor to account for different sized footrests.

Further, the first surface 112 of the first part 110 may include a surface area that may fall within a range of about K(16 square inches to 112 square inches). Alternatively, the surface area of the first surface 112 may be between a range of about K(36 square inches to 75 square inches). In another alternative, the surface area of the first surface 112 may be between a range of about K(40 square inches to 60 square inches). It is to be understood that all values falling within the ranges provided above are within the scope of the disclosure. It will be appreciated that K is a constant between 0.8 and 1.2 and may be used as a scaling factor to account for different sized footrests.

Different sizes of footrests will of course be provided depending upon the size of the vehicle in connection with which the footrests will be used. However, since the footrests may be similarly shaped, the size and shape can be represented for all standard footrests together and can be adapted by a conversion or scaling factor K, which may specify the size ratio of the respective footrests and may be between 0.8 and 1.2.

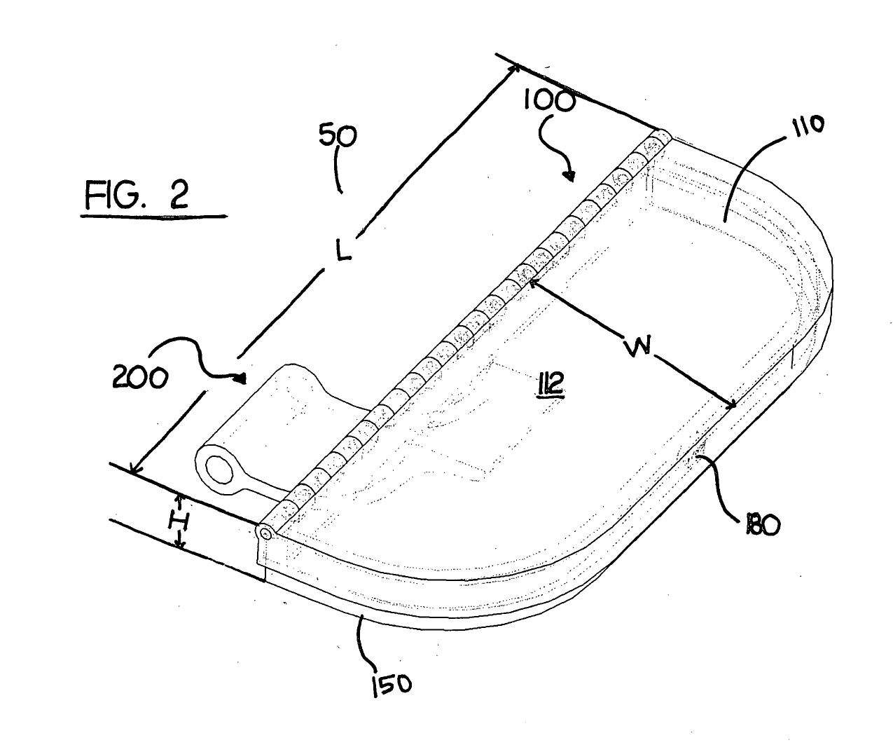

An example of the dimensions of the footrest 100 may include a length dimension “L” that may be within a range of about eight inches to about sixteen inches, a width dimension “W” that may be within a range of about two inches to about seven inches, and a height or thickness dimension “H” that may be within a range of about three-quarters of an inch to about three inches. The length dimension “L,” the width dimension “W,” and the height or thickness dimension “H” is illustrated best in FIG. 2. It will be appreciated that all values falling within the ranges provided above for the length dimension “L,” the width dimension “W,” and the height or thickness dimension “H” are within the scope of the disclosure.

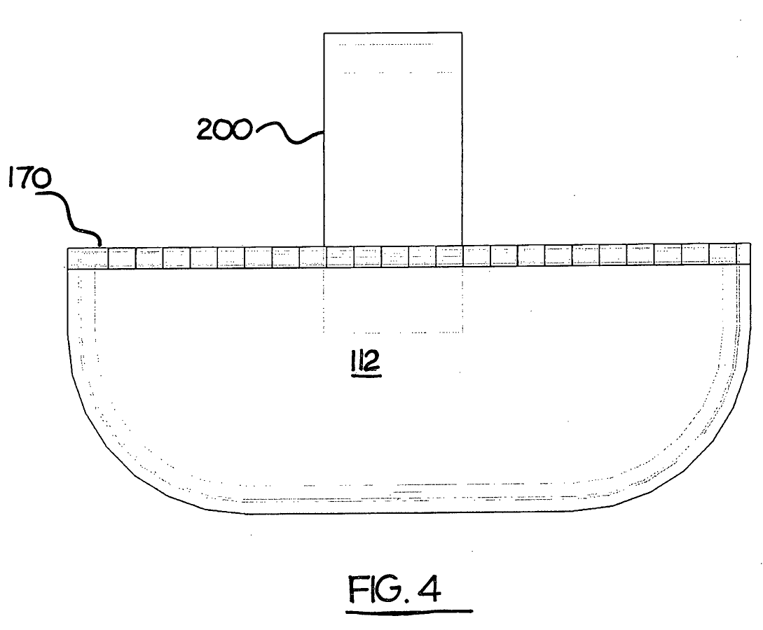

Referring now specifically to FIGS. 2 and 4, the first surface 112 may be a top surface of the first part 110 and may be configured and arranged for supporting a rider's foot. The top surface 112 may include a slip resistant mechanism 114. It will be understood that the slip resistant mechanism 114 may be any texture that is either part of the footrest 100 itself or that may be physically applied to the footrest 100, such as grooves, checkered patterns, or small protrusions extending from the first surface 112 of the footrest 100 to form a textured surface. It will be appreciated that the slip resistant mechanism 114 may also be an insert, whether made of rubber or another material, having an anti-slip pattern on the insert without departing from the spirit or scope of the disclosure. It will be appreciated that such slip resistant mechanisms 114 are well known in the art, and any such slip resistant mechanism known, or that may become known, in the art is intended to fall within the scope of the disclosure.

As best illustrated in FIGS. 1, 3 and 8, the second part 150 of the footrest 100 may comprise a sidewall 154 that may define the substantially hollow interior 152 or well 152. It will be appreciated that as used herein the terms “hollow interior” or “well” may be any recessed area or depression formed in a structural member. It will be appreciated that the hollow interior or well 152 may be used for holding any item or items, whether tools, personal property or otherwise.

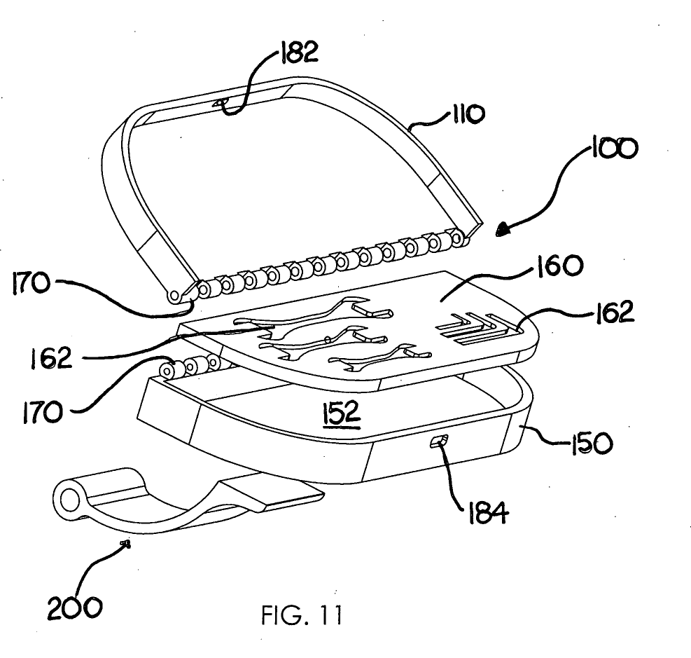

Referring briefly to FIG. 11, the second part 150 of the footrest 100 may comprise an insert 160, which may be a foam or other material, that may be sized and shaped to be located and secured within the substantially hollow interior or well 152 of the second part 150. The insert 160 may comprise a cutout 162 or, alternatively, a plurality of cutouts 162, each of which may be configured and adapted for holding or securing standard or metric sized tools. The insert 160 may also be used to hold and secure other items besides tools, such as personal property, without departing from the scope of the disclosure. Thus, the insert 160 may operate to secure tools or other items in place within the footrest 100.

As illustrated in FIGS. 1-4 and 7-9, the first part 110 may be pivotally connected to the second part 150 of the footrest 100 by a hinge 170. The hinge 170 may be for example a stainless steel piano hinge, or the hinge 170 may be any other device that movably connects the first part 110 to the second part 150. It will be appreciated that the hinge device may be made from any suitable material, such as a metallic material or a hard polymeric material, without departing from the spirit or scope of the disclosure.

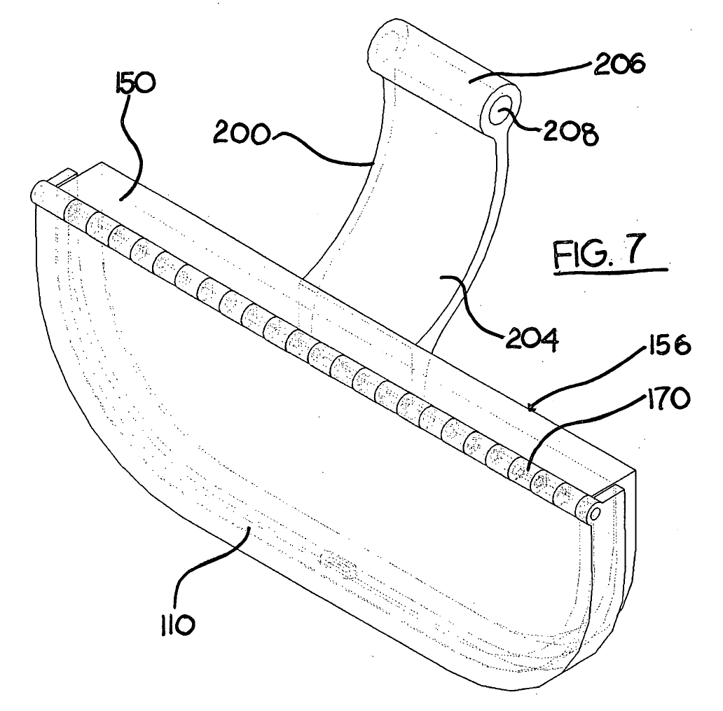

It is to be understood that the first part 110 may be movable with respect to the second part 150 of the footrest 100 and the first part 110 may be positioned in a plurality of positions with respect to the second part 150. For example, the first part 110 may be positioned in an open position (see FIGS. 1 and 3) and a closed position (see FIGS. 2 and 7).

It will be understood that the footrest 100 itself may be a driver's footrest or a passenger's footrest. Further, the footrest 100 may be manufactured for each side of the vehicle, whether the vehicle is a motorcycle or some other recreational vehicle. The footrest 100 may be either a footpeg or a floorboard without departing from the spirit or scope of the disclosure.

Referring now to FIGS. 1, 3, 6, 10 and 11, the footrest 100 may comprise a closure 180 for holding the first part 110 and the second part 150 together to form a substantially closed container. The closure 180 may be comprised of a protrusion 182 and a corresponding recess 184. The protrusion 182 may be located on an inner lip or inside portion 115 of the first part 110. The recess 184, on the other hand, may be located on an outer portion 155 of the sidewall 154 of the second part 150 (illustrated best in FIG. 3). It will be appreciated that the protrusion 182 may matingly engage the recess 184 when the first part 110 is in a closed position with respect to the second part 150. The protrusion 182 may be sized large enough to clasp the recess 184, but small enough to be unclasped from the recess 184 and thereby allowed to open. It will be appreciated that any closure 180 known, or that may become known, in the art for securing a first part 110 to a second part 150 in a closeable position may be utilized without departing from the spirit or scope of the disclosure.

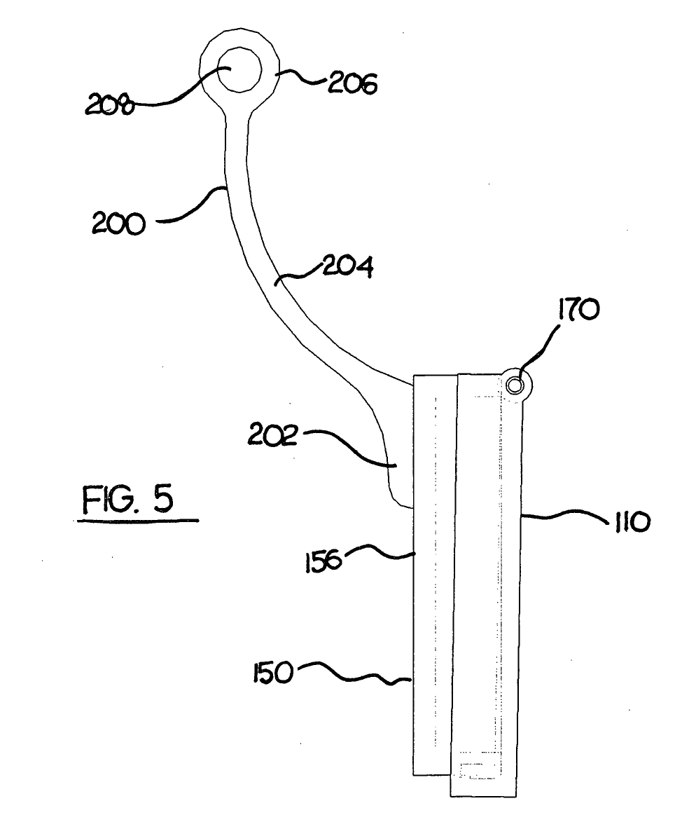

Referring now to FIGS. 1, 2, 5, 7, 9 and 11, the kit 50 may further comprise a mounting structure 200. The mounting structure 200 may be a universal mount that may be attached to a number of different vehicle makes and types, or the mounting structure 200 may be a specifically crafted or manufactured mount that is specific to a vehicle make and type. As illustrated best in FIG. 5, the mounting structure 200 may be secured to a bottom surface 156 of the second part 150 of the footrest 100. The mounting structure 200 may be attached to the bottom surface 156 of the second part 150 in a variety of ways that are known in the art, for example, with nuts and bolts, a weld, or other fasteners, or by way of fasteners that may become known in the future in the art, without departing from the spirit and scope of the disclosure.

As illustrated best in FIG. 5, the mounting structure 200 may include a base 202 that may operate to attach the mounting structure 200 to the bottom surface 156 of the second part 150. An arm 204 extend outwardly from the base 202. The arm 204 may terminate at a head 206. The head 206 may comprise an opening 208 extending therethrough to permit a fastener (not shown) to attach the head 206 of the mounting structure 200 to the vehicle, such as a motorcycle or other recreational vehicle.

It will be appreciated that the footrest 100, including the first part 110 and the second part 150, may be made or manufactured from a billet of aluminum or aluminum alloy. More specifically, the footrest 100 of the disclosure may be milled from aluminum or aluminum alloy. It will be appreciated that since pure aluminum is a relatively ductile metal, an aluminum alloy may be used, such as 6061-T6 aluminum, which is a lighter, stronger, more corrosion-resistant than pure aluminum and may be better suited for motorcycles and other recreational vehicles. It will be appreciated that other metals and non-metallic materials, such as ceramics or polymers, may be used as an alternative to aluminum, without departing from the spirit or scope of the disclosure. Further, while it may be advantageous to mill the footrest 100 or container from a block of aluminum or aluminum alloy, other manufacturing methods may be used, for example die-casting, where a metallic material may be heated and punched to shape and size creating a work hardened surface with predetermined characteristics.

In an alternative embodiment, the footrest 100 may be pivotable about an axis, for example a horizontal axis extending outwardly from the vehicle. The pivot motion may allow a rider to move the footrest 100 back and forth in a toe to heel direction. In other words, the footrest 100 may be rockable with respect to the horizontal axis in a toe to heel direction.

In accordance with the features and combinations described above, a useful method of making a vehicle footrest may comprise the steps of:

(a) forming a vehicle footrest comprising a first part having a first surface configured and arranged for supporting a rider's foot and a second part comprising a substantially hollow interior; and

(b) connecting the first part to the second part, such that the first part is movable with respect to the second part and may be positioned in a plurality of positions, including an open position and a closed position;

wherein a volume of the substantially hollow interior of the second part is K(12 cubic inches to 336 cubic inches) and a surface area of the first surface of the first part is K(16 square inches to 112 square inches);

wherein K is a constant between 0.8 and 1.2.

Those having ordinary skill in the relevant art will appreciate the advantages provide by the features of the disclosure. For example, it is a potential feature of the disclosure to provide a vehicle footrest kit comprising a footrest and a mounting structure that is simple in design and manufacture. It is a potential feature of the disclosure to provide a hollow interior in the footrest for storage of items, such as tools or other personal property. Another potential feature of the disclosure is to provide such a footrest that includes a hinged connection, such that one side of the footrest is capable of opening and closing easily with respect to the opposite side to allow a rider access to the items stored within the footrest. It is another potential feature of the disclosure to provide such a footrest for the right and left hand side of a vehicle and to provide a driver's footrest or a passenger's footrest. It is another potential feature of the disclosure to provide an insert, which may be a foam material, that may be sized and shaped to be located and secured within the substantially hollow interior of the footrest. It is another potential feature of the disclosure to provide such a footrest that is made from aluminum or aluminum alloy, other metallic or non-metallic materials.

In the foregoing Detailed Description, various features of the disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A vehicle footrest comprising:
a first part comprising a first surface configured and arranged for supporting a rider's foot; and
a second part connectable to the first part and comprising a sidewall that defines a substantially hollow interior;
wherein a volume of the substantially hollow interior of the second part is about K(36 cubic inches to 225 cubic inches) and a surface area of the first surface of the first part is about K(36 square inches to 75 square inches);
wherein K is a constant between 0.8 and 1.2.

2. The vehicle footrest of claim 1, wherein the first part is pivotally connected to the second part by a hinge, such that the first part is movable with respect to the second part and may be positioned in a plurality of positions, including an open position and a closed position.

3. The vehicle footrest of claim 1, wherein the footrest comprises a closure for holding the first part and the second part together to form a substantially closed container.

4. The vehicle footrest of claim 3, wherein the closure comprises a protrusion located on an inner portion of the first part and a corresponding recess located on an outer portion of the second part, wherein the protrusion matingly engages the recess when the first part is in a closed position with respect to the second part.

5. The vehicle footrest of claim 1, wherein the first surface is a top surface configured and arranged for supporting a rider's foot, wherein the top surface comprises a slip resistant mechanism, and wherein the second part comprises a sidewall that defines a well, thereby providing the substantially hollow interior of the second part of the footrest.

6. The vehicle footrest of claim 1, wherein the footrest comprises a driver's footrest and a passenger's footrest.

7. The vehicle footrest of claim 1, wherein the first part and the second part are made from aluminum or aluminum alloy.

8. The vehicle footrest of claim 1, wherein the footrest comprises a footrest for each side of the vehicle.

9. The vehicle footrest of claim 1, wherein the second part comprises an insert sized and shaped to be secured within the substantially hollow interior of the second part, wherein the insert comprises a plurality of cutouts configured and adapted for holding standard or metric sized tools and for securing tools in place within the footrest.

10. The vehicle footrest of claim 1, wherein the footrest is a floorboard.

11. The vehicle footrest of claim 10, wherein the floorboard comprises a length dimension that is within a range of about eight inches to about sixteen inches, a width dimension that is within a range of about two inches to about seven inches, and a thickness dimension that is within a range of about three-quarters of an inch to about three inches.

12. The vehicle footrest of claim 1, wherein the footrest is a footpeg.

13. A vehicle footrest kit comprising:
a footrest comprising a first part having a first surface and a second part connectable to the first part and comprising a substantially hollow interior; and
a mounting structure for connecting the footrest to the vehicle;
wherein a volume of the substantially hollow interior of the second part is about K(36 cubic inches to 225 cubic inches) and a surface area of the first surface of the first part is about K(36 square inches to 75 square inches);
wherein K is a constant between 0.8 and 1.2.

14. The vehicle footrest kit of claim 13, wherein the first surface is a top surface configured and arranged for supporting a rider's foot, wherein the top surface comprises a slip resistant mechanism, and the second part comprises a sidewall that defines a well, thereby providing the substantially hollow interior of the second part of the footrest.

15. The vehicle footrest kit of claim 13, wherein the first part is pivotally connected to the second part by a hinge, wherein the first part is movable with respect to the second part and may be positioned in a plurality of positions, including an open position and a closed position.

16. The vehicle footrest kit of claim 13, wherein the footrest comprises a driver's footrest and a passenger's footrest.

17. The vehicle footrest kit of claim 13, wherein the footrest comprises a closure for holding the first part and the second part together to form a substantially closed container.

18. The vehicle footrest of claim 17, wherein the closure comprises a protrusion located on an inner portion of the first part and a corresponding recess located on an outer portion of the second part, wherein the protrusion matingly engages the recess when the first part is in a closed position with respect to the second part.

19. The vehicle footrest kit of claim 13, wherein the first part and the second part of the footrest are made from aluminum or aluminum alloy.

20. The vehicle footrest kit of claim 13, wherein the kit comprises a footrest for each side of the vehicle.

21. The vehicle footrest kit of claim 13, wherein the second part comprises an insert sized and shaped to be secured within the substantially hollow interior of the second part, wherein the insert comprises a plurality of cutouts configured and adapted for holding standard or metric sized tools and for securing tools in place within the footrest.

22. The vehicle footrest kit of claim 13, wherein the footrest is a floorboard.

23. The vehicle footrest kit of claim 22, wherein the floorboard comprises a length dimension that is within a range of about eight inches to about sixteen inches, a width dimension that is within a range of about two inches to about seven inches, and a thickness dimension that is within a range of about three-quarters of an inch to about three inches.

24. The vehicle footrest of claim 13, wherein the footrest is a footpeg.

25. A method of using a vehicle footrest comprising the steps of:
(a) storing items in a vehicle footrest comprising a first part having a first surface configured and arranged for supporting a rider's foot and a second part comprising a substantially hollow interior; and
(b) connecting the first part to the second part, such that the first part is movable with respect to the second part and may be positioned in a plurality of positions, including an open position and a closed position;
wherein a volume of the substantially hollow interior of the second part is about K(36 cubic inches to 225 cubic inches) and a surface area of the first surface of the first part is about K(36 square inches to 75 square inches);
wherein K is a constant between 0.8 and 1.2.

26. The method of claim 25, wherein the first part and the second part are made from aluminum or aluminum alloy.

27. The method of claim 25, wherein the first surface is a top surface comprising a slip resistant mechanism, and the second part comprises a sidewall that defines a well, thereby providing the substantially hollow interior of the second part of the footrest.

28. The method of claim 25, wherein the first part is pivotally connected to the second part by a hinge.

29. The method of claim 25, wherein the footrest comprises a driver's footrest and a passenger's footrest.

30. The method of claim 25, wherein the footrest comprises a closure for holding the first part and the second part together to form a substantially closed container.

31. The method of claim 30, wherein the closure comprises a protrusion located on an inner portion of the first part and a corresponding recess located on an outer portion of the second part, wherein the protrusion matingly engages the recess when the first part is in a closed position with respect to the second part.

32. The method of claim 25, wherein the footrest comprises a footrest for each side of the vehicle.

33. The method of claim 25, wherein the method includes providing an insert sized and shaped to be secured within the substantially hollow interior of the second part, wherein the insert comprises a plurality of cutouts configured and adapted for holding standard or metric sized tools and for securing tools in place within the footrest.

34. The method of claim 25, wherein the footrest is a floorboard.

35. The method of claim 25, wherein the footrest is a footpeg.

36. The method of claim 25, wherein the step of manufacturing a footrest comprises milling the footrest from a billet of aluminum or aluminum alloy.

37. The method of claim 25, wherein the step of manufacturing a footrest comprises die-casting a metallic material, wherein the metallic material is heated and punched to a specific shape and size thereby creating a work hardened surface with predetermined characteristics.
